(19) United States
(12) Patent Application Publication
(10) Pub. No.: US 2011/0075250 A1
(43) Pub. Date: Mar. 31, 2011

(54) LASER SCANNING BEAM READER

(75) Inventor: Ching-Chung Wang, Taipei (TW)

(73) Assignee: PRIMAX ELECTRONICS LTD., Taipei (TW)

(21) Appl. No.: 12/646,000

(22) Filed: Dec. 23, 2009

(30) Foreign Application Priority Data
Sep. 25, 2009 (TW) 098132390

(51) Int. Cl. G02F 1/29; G02B 27/44

(52) U.S. Cl. 359/298; 359/569; 359/575

(57) ABSTRACT

A laser scanning beam reader is provided. When a round-grating-dot matrix is in a stationary state, the laser beams passing through the round-grating-dot matrix result in line-shaped refraction beams. By the laser scanning beam reader, the motor system conventionally used for rotating the hologram disc to successively generate dot scanning beams as the line-shaped will be omitted. As a consequence, the components and configurations of the laser scanning beam reader are simplified and the cost thereof is reduced.

### FIELD OF THE INVENTION

The present invention relates to a scanning beam reader, and more particularly to a laser scanning beam reader.

### BACKGROUND OF THE INVENTION

A laser scanning technology is widely used in many products and fields such as barcode readers, scanners, laser distance meters, or a like. For example, a barcode reader is an electronic device for reading printed barcodes. By using a rotatable scanning element to deflect and focus laser beams into a scanning pattern with plural parallel or cross lines, the barcode reader could read out the printed barcode on an article. After the signals reflected from the barcode are received, the signals are processed by an electronic circuit and a decoder in order to be further discriminated, analyzed and managed.

Generally, the above laser scanning product generates the beams for scanning a two-dimensional barcode under the cooperation of an optical system and a motor system. The optical system includes a prism and/or a lens assembly. As known, the optical system and the motor system have complicated configuration and are not cost-effective. Recently, a hologram disc is used to produce the scanning pattern. The hologram disc includes a plurality of gratings. By adjusting the pitch and the azimuth angle of the gratings, the light beams incident to the hologram disc are diffracted by the gratings so as to produce diffracted light beams. For example, U.S. Pat. No. 5,237,160 has disclosed a hologram disc having a plurality of gratings. An optical system is used for receiving the laser beams. When the hologram disc is rotated by a motor system, consecutive scanning patterns are generated. However, high cost may be still an issue for such an application of hologram disc because it is equipped with complicated and expensive optical system and the motor system. Furthermore, the optical system and the motor system are easily suffered from vibration or shock impact.

### SUMMARY OF THE INVENTION

For obviating the drawbacks encountered from the prior art, a scanning beam generating device is provided herein, in which a plurality of round grating dots are arranged on a plane in a matrix and thus the motor system for rotating the hologram disc is omitted.

Moreover, a laser scanning beam reader is equipped with a stationary round-grating-dot matrix. The laser beams passing through the round-grating-dot matrix result in line-shaped refraction beams. The diffraction angles of the refraction beams generated from the round-grating-dot matrix in the stationary state are detectable. As a consequence, the device for modulating the scanning beams could be simplified or omitted.

Accordingly, the laser scanning beam reader includes a laser source module, a scanning beam generating module and a detecting module. The laser source module is used for generating laser beams. The scanning beam generating module is used for receiving the laser beams from the laser source module. The scanning beam generating module includes a round-grating-dot matrix. The laser beams passing through the stationary round-grating-dot matrix result in line-shaped scanning beams that are composed of dot refraction beams. The detecting module is used for receiving reflective beams that are generated when the line-shaped scanning beams are reflected by the article.

In the scanning beam generating module, the round-grating-dot matrix includes a plurality of round grating dots arranged in a two-dimensional array, and each of the round grating dots includes a plurality of parallel grating fringes. The grating fringes in each of the round grating dots have an azimuth angle, and the azimuth angle of one round grating dots may be different from other round grating dots. In an embodiment, every two grating fringes of each of the round grating dots are separated from each other by a pitch, wherein all pitches in each of the round grating dots may be identical. In another embodiment, every two grating fringes of each of the round grating dots are separated from each other by a pitch, wherein the pitches between different grating fringes are different. In another embodiment, each of the round grating dots has a diameter, wherein all round grating dots have the same diameter.

In an embodiment, the laser scanning beam reader further includes a modulation module between the laser source module and the scanning beam generating module for adjusting an incidence angle of the dot beams with respect to the round-grating-dot matrix.

In an embodiment, the laser scanning beam reader further includes a shielding plate. The laser beams are processed by the scanning beam generating module into diffraction beams. Undesired portions of the diffraction beams are filtered off by the shielding plate, thereby producing the line-shaped scanning beams.

In an embodiment, the laser scanning beam reader further includes a modulation module between the article and the detecting module for adjusting a propagating direction of the reflective beams to the detecting module.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic planar view illustrating a laser scanning beam generating device according to an embodiment of the present invention;

FIG. 2A is a schematic planar view illustrating a laser scanning beam generating device according to another embodiment of the present invention;

FIG. 2B is a schematic planar view illustrating a laser scanning beam generating device according to another embodiment of the present invention;

FIG. 2C is a schematic planar view illustrating a laser scanning beam generating device according to another embodiment of the present invention;

FIG. 3 is a schematic view illustrating a laser scanning beam reader according to an embodiment of the present invention; and

FIG. 4 is a schematic view illustrating a laser scanning beam reader according to another embodiment of the present invention.

### DETAILED DESCRIPTION OF THE PREFERRED EMBODIMENT

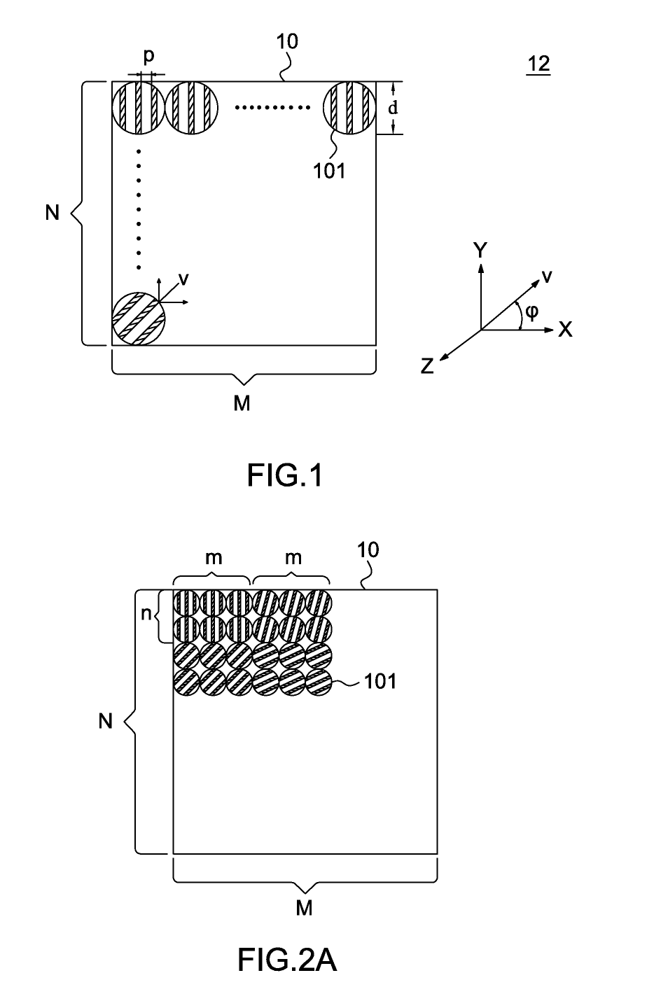

FIG. 1 is a schematic planar view illustrating a laser scanning beam generating device according to an embodiment of the present invention. The laser scanning beam generating device comprises a round-grating-dot matrix 10. The round-grating-dot matrix 10 is an N-by-M matrix with M columns and N rows of round grating dots 101, where M and N are integers greater than 1, and M and N may be identical or different. In this context, the round-grating-dot matrix 10 could also be referred as a two-dimensional array or a two-dimensional array of N-by-M matrix. The round-grating-dot matrix 10 is arranged on a plane 12. Each of the round grating dots 101 has a diameter “d” and comprises a plurality of parallel grating fringes. Every two parallel grating fringes are separated from each other by a pitch “p”. These parallel grating fringes are oriented in a vector “v”. In this embodiment, the plane 12 is an X-Y plane 12. An azimuth angle ψ is defined between the vector v of the parallel grating fringes and the X-axis of the X-Y plane 12. In an embodiment, the pitch “p” is designed such that the light beams passing through the grating fringes are subject to diffraction. In the two-dimensional array of N-by-M matrix, the grating fringes of all round grating dots 101 have the same pitch p. Moreover, in the two-dimensional array of N-by-M matrix, all round grating dots 101 have the same diameter d. In other words, the numbers of grating fringes for all round grating dots 101 are equal.

In some embodiments, different round grating dots 101 in the two-dimensional array of N-by-M matrix have different diameters d. As such, different round grating dots 101 have different numbers of grating fringes. In this embodiment, the grating fringes of all round grating dots 101 have the same azimuth angle ψ. Alternatively, the grating fringes of different round grating dots 101 may have different azimuth angles ψ.

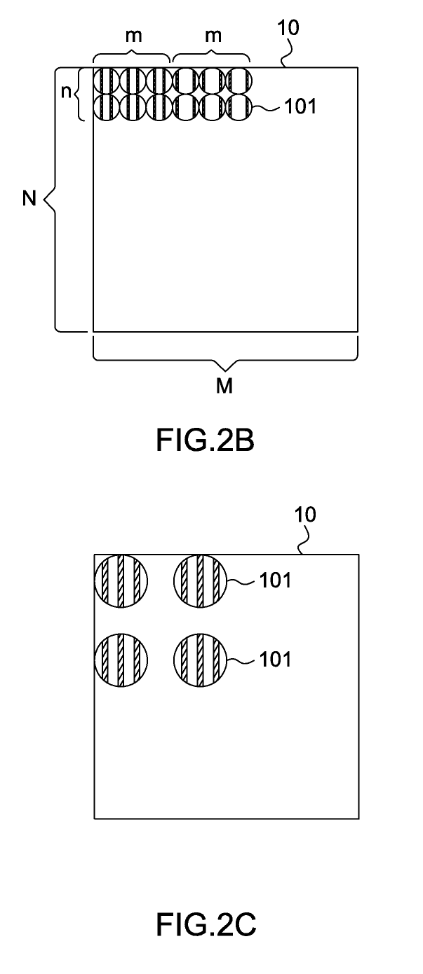

FIG. 2A is a schematic planar view illustrating a laser scanning beam generating device according to another embodiment of the present invention. As shown in FIG. 2A, the two-dimensional array of N-by-M matrix is divided into several sub-matrices. For example, a sub-matrix is a n-by-m sub-matrix with m rows and n columns of round grating dots 101, where m is smaller than M and n is smaller than N. For each n-by-m sub-matrix, the grating fringes of all round grating dots 101 have the same azimuth angle ψ. For different n-by-m sub-matrix sub-matrices, the grating fringes of the round grating dots 101 have different azimuth angles ψ. The round-grating-dot matrix 10 could be used as the laser scanning beam generating device of a laser scanning beam reader.

FIG. 2B is a schematic planar view illustrating a laser scanning beam generating device according to another embodiment of the present invention. As shown in FIG. 2B, the two-dimensional array of N-by-M matrix is divided into several sub-matrices. In the two-dimensional array of N-by-M matrix, all round grating dots 101 have the same diameter d. For different sub-matrices, the grating fringes of the round grating dots 101 have different pitches p. The pitches p may be irregularly varied. For example, for the sub-matrices with the same column number, as the row number is increased, the pitch p is increased or decreased.

FIG. 2C is a schematic planar view illustrating a laser scanning beam generating device according to another embodiment of the present invention. As shown in FIG. 2C, every two adjacent round grating dots 101 of the two-dimensional matrix are separated from each other by a gap. Under this circumstance, these round grating dots 101 are regularly arranged in the two-dimensional matrix. The laser scanning beam generating device of FIG. 2C is still capable of generating line-patterned scanning beams. In a case that the laser light beams passing through the gaps between the round grating dots 101, the diffraction phenomenon perhaps does not occur. Whereas, only the laser light beams passing through the grating fringes of the round grating dots 101 are subject to diffraction.

In the two-dimensional matrices of the above embodiments, the elements of all columns or rows could be identical or different so long as the elements of the columns or rows are arranged in a line.

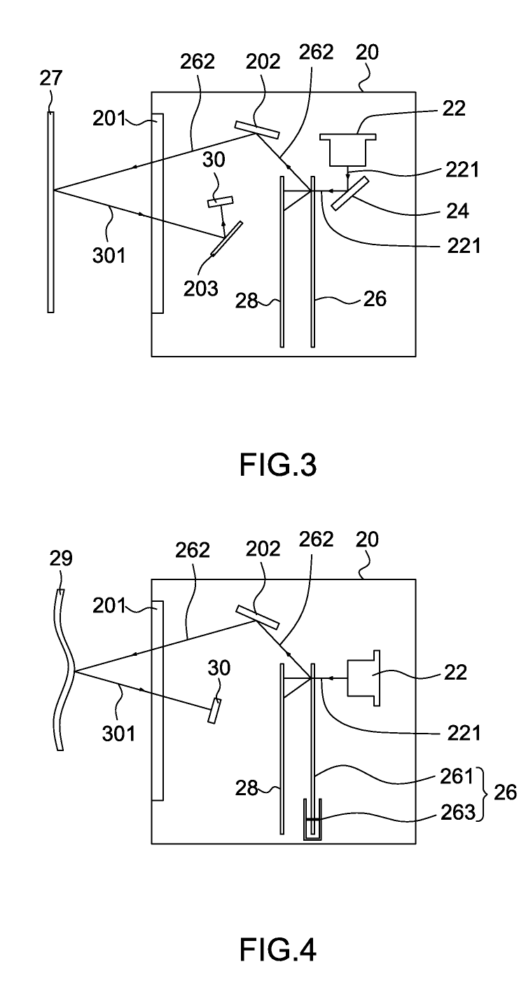

FIG. 3 is a schematic view illustrating a laser scanning beam reader according to an embodiment of the present invention. As shown in FIG. 3, the laser scanning beam reader comprises a housing 20, a laser source module 22, a modulation module 24, a scanning beam generating module 26, a sheltering plate 28 and a detecting module 30. The components of the laser scanning beam reader are protected within the housing 20. An example of the laser source module 22 includes but is not limited to a semiconductor laser source/collimator lens module. The laser source module 22 is disposed within the housing 20 for generating visible or invisible dot beams 221 of a single wavelength. Since the diversion angles of laser beams are very tiny, the dot beams 221 could be considered as the combination of plural parallel beams. Alternatively, in a case that the space within the housing is sufficient, a processing element (not shown) is arranged in the optical path of the dot beams 221, and the dot beams 221 are processed into parallel beams before the dot beams 221 are incident to the scanning beam generating module 26.

An example of the modulation module 24 is a reflective mirror. Along the optical path of the dot beams 221, the modulation module 24 is arranged in front of the scanning beam generating module 26. The modulation module 24 is used for adjusting the incidence angle of the dot beams 221 with respect to the round-grating-dot matrix of the scanning beam generating module 26. In this embodiment, the incidence angle of the dot beams 221 is adjusted by the modulation module 24 such that the dot beams 221 are vertically incident to the round-grating-dot matrix of the scanning beam generating module 26. Please refer to FIGS. 1 and 3. The round-grating-dot matrix is arranged on an X-Y plane 12. The dot beams 221 are adjusted by the modulation module 24 (a first modulation module), so that the dot beams 221 are incident to the X-Y plane 12 along the Z-axis direction.

In some embodiments, the modulation module is integrated into the scanning beam generating module 26. As such, the angle of the plane where the round-grating-dot matrix may be adjusted by the scanning beam generating module 26. As shown in FIG. 4, the scanning beam generating module 26 comprises a circular disk 261 and a modulation module 263. The round-grating-dot matrix is arranged on the circular disk 261. The modulation module 263 is an adjustable holder for holding the circular disk 261 and adjusting the angle of the circular disk 261 with respect to the dot beams 221.

Alternatively, the modulation module could be integrated into the laser source module 22. As such, the incidence angle of the dot beams 221 with respect to the scanning beam generating module 26 is directly controlled by the laser source module 22.

The scanning beam generating module 26 may include the round-grating-dot matrix as shown in FIG. 1, FIG. 2A, FIG. 2B or FIG. 2C. After the dot beams 221 are incident to the scanning beam generating module 26, diffraction beams 262 are outputted in a specified direction. The specified direction is dependent on the incidence angle of the dot beams 221, the wavelength of the light beams and the pitches of the grating fringes of the round-grating-dot matrix. The diffraction beams 262 are 0-order, +1-order or −1-order diffraction beams. The diffraction beams 262 are preferably +1-order or −1-order diffraction beams. The round-grating-dot matrix comprises a plurality of round grating dots. Since each of the round grating dots could diffract light beams, the dot beams 221 passing through the round-grating-dot matrix result in line-shaped or strip-shaped light beams, which are composed of dot refraction beams and directly used as the scanning beams. On the other hand, when a hologram disc is used to produce the scanning beams according to the conventional laser scanning barcode reader, the motor system is necessary to rotate the hologram disc to successively generate dot scanning beams to result in the line-shaped or strip-shaped light beams because only one dot scanning beam is generated for each time. According to the present invention, when the round-grating-dot matrix is in a stationary state, the laser beams passing through the round-grating-dot matrix result in line-shaped scanning beams that are composed of dot refraction beams. As a consequence, no additional motor system is required for rotating the round-grating-dot matrix.

Please refer to FIG. 3 again. The diffraction beams generated by the scanning beam generating module 26 are processed by a shielding plate 28, so that undesired portions of the diffraction beams are filtered off but the desired portions of the diffraction beams are remained. For example, in a case that the desired portions of the diffraction beams include the +1-order diffraction beams, the 0-order and −1-order diffraction beams are filtered off by the shielding plate 28. In an embodiment, for filtering off the undesired portions of the diffraction beams, the shielding plate 28 is arranged between the scanning beam generating module 26 and a window 201 of the housing 20. The remained portions of the diffraction beams 262 are propagated out of the laser scanning beam reader through the window 201 of the housing 20 to be used as the scanning beams. In this embodiment, another modulation module 202 (a second modulation module) is arranged at a proper location between the scanning beam generating module 26 and the window 201 for adjusting a propagating direction of the diffraction beams 262 so as to assure that the diffraction beams 262 are propagated out of the laser scanning beam reader through the window 201. Since the laser beams passing through the round-grating-dot matrix result in line-shaped or strip-shaped scanning beams when the round-grating-dot matrix is in a stationary state, the location of the modulation module 202 is designed such that the line-shaped or strip-shaped scanning beams are propagated through the window 201. As known, in designing a device for rotating a hologram disc when the hologram disc of a conventional laser scanning barcode reader is used to produce the scanning beams, the propagating direction of the diffraction beams is adjusted as the hologram disc is rotated. In comparison with the device for rotating the hologram disc, the modulation module used for the round-grating-dot matrix result could be simplified according to the present invention.

Please refer to FIG. 3 again. The diffraction beams 262 propagated through the window 201 are used as the scanning beams. The scanning beams could be directed to a barcode or another article 27 that contains optical information. The scanning beams are reflected by the barcode or the article 27 to generate reflective beams 301. The reflective beams 301 are directed into the laser scanning beam reader through the window 201. Moreover, a third modulation module 203 is disposed within the housing 20 for adjusting the propagating direction of the reflective beams 301. The reflective beams 301 are received by the detecting module 30 (e.g. a light detector) to be further processed.

Please refer to FIG. 4 again. In this embodiment, no third modulation module 203 is included within the housing 20. The detecting module 30 is arranged at a proper location such that the reflective beams 301 from the article 29 are directed to the detecting module 30 through the window 201 to be further processed.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A laser scanning beam reader for use with an article, said laser scanning beam reader comprising:
a laser source module for generating laser beams;
a scanning beam generating module for receiving said laser beams from said laser source module, said scanning beam generating module comprising a round-grating-dot matrix, wherein when said round-grating-dot matrix is in a stationary state, said laser beams passing through said round-grating-dot matrix result in line-shaped scanning beams that are composed of dot refraction beams; and
a detecting module for receiving reflective beams, wherein said reflective beams are derived from said line-shaped scanning beams reflected by said article.

2. The laser scanning beam reader according to claim 1, wherein said round-grating-dot matrix comprises a plurality of round grating dots arranged in a two-dimensional array, and each of said round grating dots comprises a plurality of parallel grating fringes.

3. The laser scanning beam reader according to claim 2, wherein said grating fringes in each of said round grating dots have an azimuth angle, wherein different round grating dots have different azimuth angles.

4. The laser scanning beam reader according to claim 2, wherein every two grating fringes in each of said round grating dots are separated from each other by a pitch and all pitches of each of said round grating dots are identical.

5. The laser scanning beam reader according to claim 2, wherein every two grating fringes in each of said round grating dots are separated from each other by a pitch and said pitches between different grating fringes are different.

6. The laser scanning beam reader according to claim 2, wherein each of said round grating dots has a diameter and all round grating dots have the same diameter.

7. The laser scanning beam reader according to claim 2, wherein every two adjacent round grating dots are separated from each other by a gap.

8. The laser scanning beam reader according to claim 1 further comprising a modulation module between said laser source module and said scanning beam generating module for adjusting an incidence angle of said dot beams with respect to said round-grating-dot matrix.

9. The laser scanning beam reader according to claim 1 further comprising a shielding plate, wherein said laser beams are processed by said scanning beam generating module into diffraction beams, and a portion of said diffraction beams are filtered off by said shielding plate to form said line-shaped scanning beams.

10. The laser scanning beam reader according to claim 1, wherein said scanning beam generating module further comprises a modulation module for adjusting an incidence angle of said dot beams with respect to said round-grating-dot matrix.

11. The laser scanning beam reader according to claim 10 further comprising a shielding plate, wherein said laser beams are processed by said scanning beam generating module into diffraction beams, and a portion of said diffraction beams are filtered off by said shielding plate to form said line-shaped scanning beams.

12. The laser scanning beam reader according to claim 1 further comprising a modulation module between said article and said detecting module for adjusting a propagating direction of said reflective beams to said detecting module.
